(19) United States
(12) Patent Application Publication
(10) Pub. No.: US 2018/0370848 A1
(43) Pub. Date: Dec. 27, 2018

(54) METHOD FOR POLISHING A PHOSPHATE GLASS OR A FLUOROPHOSPHATE GLASS SUBSTRATE

(71) Applicant: Rhodia Operations, Paris (FR)

(72) Inventors: Wei Hong SONG, Shanghai (CN); Ning ZHU, Shanghai (CN); Shangjun DING, Shanghai (CN); Haiting WU, Shanghai (CN); Qian WANG, Shanghai (CN)

(21) Appl. No.: 16/062,943

(22) PCT Filed: Dec. 14, 2016
(86) PCT No.: PCT/EP2016/080967

§ 371 Date: Jun. 15, 2018

(30) Foreign Application Priority Data
Dec. 16, 2015 (CN) PCT/CN2015/097536

(51) Int. Cl. C03C 15/02; C09G 1/02

(52) U.S. Cl. CPC C03C 15/02; C03C 3/16; C09G 1/02

(57) ABSTRACT

The present invention concerns a method for polishing a phosphate glass or fluorophosphate glass substrate comprising polishing the surface of said substrate using at least a formulation having a pH comprised between 7 and 14 comprising at least a cerium containing abrasive, an anionic water-soluble polymer dispersant, an anti-caking agent, optionally a co-dispersant and water.

The present invention concerns a method for polishing a phosphate glass or fluorophosphate glass substrate comprising polishing the surface of said substrate using at least a formulation having a pH comprised between 7 and 14 comprising at least a cerium containing abrasive, an anionic water-soluble polymer dispersant, an anti-caking agent, optionally a co-dispersant and water.

### PRIOR ART

The following discussion of the prior art is provided to place the invention in an appropriate technical context and enable the advantages of it to be more fully understood. It should be appreciated, however, that any discussion of the prior art throughout the specification should not be considered as an express or implied admission that such prior art is widely known or forms part of common general knowledge in the field.

Generally, glass which using phosphate as a glass network former has excellent transmission in visible light region and low optical dispersion, and it is therefore used in fields where the transmission in said region and low dispersion property is important, for instance in optical filter application. Optical filters are usually made of colored glass which may contain phosphate as a glass network former and also comprise transition metal ion such as Fe^{e}′ or Cu^{e}′. Meanwhile, for improving phosphate glass in stability, optical constants, transmission characteristics and chemical durability, it is general practice to add alkali metal oxides, alkaline earth metal oxides, other divalent metal oxides such as ZnO, other trivalent metal oxides such as Al₂O₃, In₂O₃, Sb₂O3 or RE₂O₃, and F to a glass. When the above components are added as required, the glass can have stability sufficient for shapability and can be mass-produced without causing devitrification.

The above glass may be used for an infrared absorption filter which is a spectral luminous efficiency correction filter of CCD (charge coupled device) for use for instance in a color VTR camera. The glass used for the above filter is imparted with the property of absorbing light having a longer wavelength than 700 nm by incorporating CuO as a colorant thereinto and utilizing the absorption by Cu²⁺ ion. In this case, the Cu²⁺ exhibits excellent absorption only when phosphate is used as a main component of a glass network former. For the above filter, therefore, there is used a phosphate glass or a fluorophosphate glass to which CuO is incorporated. The glass is polished so as to have a desired thickness and surface quality, and is used as a filter for an image sensor element such as CCD. In the image sensor element, the demand for high density has been increasing, and an area per pixel of photodiode is exceedingly decreased. There is therefore a phenomenon that even a flaw or scratch having a size of the order of several micrometers which has not caused any problem so far causes a detrimental effect on an image. It is therefore required to have a highly accurate polished surface.

The above phosphate glass containing phosphate has a poor glass structure, and it is therefore liable to have polish-induced flaws and is easily chemically reactive. However, an increase in the hardness of the glass is limited in terms of the glass composition, and unlike a borosilicate glass, it is difficult to obtain a hardness sufficient for easy polishing. When desired transmission characteristics, chemical durability, glass stability adequate for mass-producibility and other optical characteristics are intended to be maintained, an improvement in the composition is limited. It is therefore difficult to impart a phosphate glass or a fluorophosphate glass with a hardness which a borosilicate glass has, and most glasses of this type is so-called least polishable glass having a low hardness.

For polishing the above phosphate glass or fluoro-phosphate glass, conventionally, there is employed a method in which the glass is polished with a polishing liquid prepared by adding an abrasive, such as CeO₂, to water. Generally, as the load for polishing is decreased or as the rotation rate for polishing is decreased, the accuracy of the polished surface of a glass having a low hardness increases. However the phosphate glass and the fluorophosphate glass not only have a considerably low hardness, but also are highly chemically reactive, and therefore, they have the following defects. They show limits in polish accuracy, latent flaws are liable to occur, and it takes a long period of time to polish them.

Furthermore, it appears that the use of known polishing formulation for phosphate glass and fluorophosphate glass will lead to a sort of foggy film or haze, either continuously or spotty, which develop on the glass surface after the polishing. Such a type of a white, semi-opaque haze will decrease glass transparency of the phosphate glass and fluorophosphate glass and negatively impact the image quality wherein said glass is used as a filter for an image sensor element.

Moreover, there is also a need to improve the long time storage of polishing formulation to avoid formation of a hard cake at the bottom of the recipient over time, usually leading to some issues with redipsersion of the abrasive and negatively impacting the surface quality of the treated surface.

### INVENTION

The present invention provides a method for polishing phosphate glass and fluorophosphate glass permitting to achieve targeted thickness without any objectionable film, haze or surface defects, such as scratches, pits, and/or residue, which forms on the glass surfaces and heretofore has not been removed. It is therefore a first object of the present invention to provide a method for effectively producing a glass product having a highly accurately polished surface, a particularly phosphate glass or fluorophosphate glass product. Formulation of the invention also has excellent suspension performance and re-dispersion behavior.

The present invention concerns then a method for polishing a phosphate glass or a fluorophosphate glass substrate comprising polishing the surface of said substrate using at least a formulation having a pH comprised between 7 and 14 and comprising at least:

a) a cerium containing abrasive;

b) an anionic water-soluble polymer dispersant;

c) optionally a co-dispersant;

d) an anti-caking agent; and

e) water.

The invention also concerns the use of a formulation as previously defined for polishing a phosphate glass or a fluorophosphate glass substrate.

Other characteristics, details and advantages of the invention will emerge even more fully upon reading the description which follows.

### Definitions

Throughout the description, including the claims, the term “comprising one” should be understood as being synonymous with the term “comprising at least one”, unless otherwise specified, and “between” should be understood as being inclusive of the limits.

It should be noted that in specifying any range of concentration, any particular upper concentration can be associated with any particular lower concentration.

As used herein, the terminology “(Cₙ-Cₘ)” in reference to an organic group, wherein n and m are each integers, indicates that the group may contain from n carbon atoms to m carbon atoms per group.

This application claims priority to PCT application No. CN2015/097536, the whole content of this application being incorporated herein by reference for all purposes.

Should the disclosure of any patents, patent applications, and publications which are incorporated herein by reference conflict with the description of the present application to the extent that it may render a term unclear, the present description shall take precedence.”

### DETAILS OF THE INVENTION

a) Cerium Containing Abrasive

Formulation of the invention may comprise from 1 to 50% by weight of cerium containing abrasive, preferably between 20 and 40% by weight, with respect to the total weight of the formulation.

Preferably, the cerium containing abrasive is selected from the group consisting of cerium oxide, lanthanum-cerium oxide, lanthanum-cerium oxide and oxyfluoride, lanthanum-cerium-praseodymium oxide and oxyfluoride, lanthanum-cerium-praseodymium-neodymium oxide and oxyfluoride or other doped cerium oxides. The cerium containing abrasive comprises preferably cerium oxide, the content of which is preferably from 30 to 90% by weight.

The particle size distribution of the cerium containing abrasive is generally comprised between 0.1 to 3 μm, preferably 0.2 to 0.8 μm. Preferably the average particle diameter D50 of the cerium containing abrasive is comprised between 0.1 to 3 μm, preferably 0.2 to 0.8 μm. D50 may be measured by a laser scattering method with a distribution in volume.

The above particle size distribution includes a particle size distribution of a secondary particle diameter of the abrasive. Such a particle size distribution may notably be obtained by grinding of more classical size cerium containing abrasives, notably by wet grinding or jet mill.

The above abrasives may be used alone or in combination with at least one other abrasive.

Primary particle size of the cerium containing abrasive may be comprised between 10 and 2000 nm, more preferably between 50 and 1000 nm. Primary particle size may be determined by scanning electronic microscope (SEM, ZEISS EVO 18) observation of abrasive particles. Secondary particle size of the cerium containing abrasives may be comprised between 100 and 5000 nm, more preferably between 200 and 2000 nm. Secondary particle size may be measured by laser scattering method with HORIBA LA-920.

b) Anionic Water-Soluble Polymer Dispersant

Water-soluble polymers may be natural or synthetic water-soluble polymers. Water-soluble polymers are substances that dissolve, disperse or swell in water and, thus, modify the physical properties of aqueous systems in the form of gelation, thickening or emulsification/stabilization. These polymers usually have repeating units or blocks of units; the polymer chains contain hydrophilic groups that are substituents or are incorporated into the backbone.

Anionic water-soluble polymer dispersants may be homopolymers or copolymers.

Anionic water-soluble polymer dispersants preferably have an average molecular weight (M_{w}) of 1,000 to 10,000 g/mol, and more preferably 2,000 to 5,000 g/mol. It is noted that the M_{w} is a measurement by gel permeation chromatography (GPC) versus polystyrene standards.

Anionic water-soluble polymer dispersants are preferably chosen in the group constituted by:
homopolymers such as polyacrylic acid, polymaleic acid, and salts thereof, and
copolymers of monomers such as acrylic acid, maleic acid, notably in any desired proportion, and salts thereof.

A polymer dispersant having ammonium, sodium or potassium acrylate salt as constituent unit as copolymer component is more preferred. Examples of polymer dispersant have ammonium, sodium or potassium acrylate salt as constituent unit as copolymer component include ammonium salt, polyacrylate salt, and ammonium salt of alkyl polyacrylate and acrylate copolymer.

A polyacrylate salt is a polyacrylic acid, the acid groups of which are totally or partially neutralized. Polyacrylate salt may be selected from the group consisting of sodium polyacrylate, potassium polyacrylate, ammonium polyacrylate, and calcium polyacrylate.

In addition to the water-soluble polymer dispersant, the formulation may also comprise at least one water-soluble anionic dispersant which may be selected in the group consisting of triethanolamine lauryl sulfate, ammonium lauryl sulfate, triethanolamine polyoxyethylene alkyl ether sulfate, polymer dispersant of polycarboxylate type.

The water-soluble polymeric dispersant may also be a polycarboxylate type. A polycarboxylate is a polymer comprising units derived from a carboxylic monomer having unsaturated double bond such as acrylic acid, methacrylic acid, maleic acid, fumaric acid, itaconic acid, copolymer of carboxylic monomer having unsaturated double bond and other monomer having unsaturated double bond, the acid groups of which are totally or partially neutralized. The neutralization may be based on an ammonium salt or amine salt of them.

Anionic water-soluble polymer dispersant concentration may be comprised between 0.001 and 5% by weight, more preferably between 0.1 and 1% by weight, based on the weight of cerium containing abrasive.

c) Co-Dispersant

Co-dispersant for the abrasive in the formulation may be chosen in the group constituted by: inorganic polyphosphates, organic phosphonates, water-soluble nonionic dispersant, water-soluble cationic dispersant, and water-soluble amphoteric dispersant.

Inorganic polyphosphates are preferably sodium hexametahposphate (HMP), sodium tripolyphosphate, sodium polyphosphate, and potassium polyphosphate.

Organic phosphonates are preferably 2-phosphonobutane-1,2,4-tricarboxylic acid (PBTCA), 1-hydroxy ethylidene-1,1-diphosphonic acid (HEDP), amino trimethylene phosphonic acid (ATMP), ethylene diamine tetra(methylene phosphonic acid) sodium (EDTMPS), 2-hydroxyphosphonocarboxylic acid (HPAA), and hexamethylene diamine tetra(methylene phosphonic acid) (HDTMPA). Organic phosphates are preferably water-soluble organic phosphates.

Examples of water-soluble nonionic dispersants include polyoxy ethylene lauryl ether, polyoxy ethylene cetyl ether, polyoxy ethylene stearyl ether, polyoxy ethylene oleyl ether, polyoxy ethylene higher alcohol ether, polyoxy ethylene octyl phenyl ether, polyoxyethylene nonyl phenyl ether, polyoxyalkylene alkylether, polyoxyethylene derivative, polyoxyethylenesorbitan mono laurate, polyoxy ethylene sorbitan monopalmitate, polyoxy ethylene sorbitan monostearate, polyoxy ethylene sorbitan tristearate, polyoxy ethyelene sorbitan mono-oleate, polyoxy ethylene sorbitan trioleate, tetraoleic polyoxy ethylene sorbit, polyethylene glycol mono laurate, polyethylene glycol monostearate, polyethylene glycol distearate, polyethylene glycol mono-oleate, polyoxy ethylene alkylamine, polyoxy ethylene cured castor oil, 2-hydroxyethyl methacrylate, and alkyl alkanolamide.

Examples of water-soluble cationic dispersant include polyvinyl pyrrolidone, coconut amine acetate, stearyl amine acetate, and hexadecyl trimethyl ammonium bromide (CTAB).

Examples of water-soluble amphoteric dispersant include lauryl betaine, stearyl betaine, lauryl dimethylamine oxide, and 2-alkyl-N-carboxymethyl-N-hydroxy ethyl imidazolinium betaine.

These dispersants may be used alone or in combination of two or more types.

The dispersant is preferably used for dispersing the cerium oxide particles stably in water or other disperse medium.

Co-dispersant concentration may be comprised between 0.01 and 3% by weight, more preferably between 0.1 and 1% by weight, based on the weight of cerium containing abrasive.

d) Anti-Caking Agent

Formulation of the invention also comprises at least an anti-caking agent, notably to reach a good re-dispersion of the formulation. An anti-caking agent is usually defined as an additive placed in powdered or granulated form to prevent the formation of lumps or clumps

The anti-caking agent is preferably chosen in the group constituted by: phyllosilicate minerals, preferably clay minerals, notably natural or synthetic smectite clay minerals.

Clay minerals may be for instance chosen in the group constituted of: smectite group, kaolinite group, vermiculite group, chlorite group, illite group, serpentine group, mica group, such as muscovite, talc group, palygorskite (or attapulgit) group, and organoclay group.

Examples of natural smectite clay minerals include montmorillonite, bentonite and hectorite (Optigel® and Gelwhite® from Rockwood) and examples of synthetic smectite clay minerals include Laponite® from Rockwood. Examples of organoclay include organic bentonite such as Claytone® and Tixogel® from Rockwood.

Anti-caking agents are preferably silicate particles such as layered silicate particles, which may swell to form colloid platelets, notably having an average diameter, preferably a average particle diameter D50 in volume comprised between 10 and 30 μm, notably as measured by laser scattering method with HORIBA LA-920.

Anti-caking agents also include amorphous precipitated silica, fumed silica, cellulose and its derivations, and sodium, magnesium or aluminum salts of some fatty acids such as palmitic acid, stearic acid and oleic acid, etc.

Formulation of the invention may comprise between 0.01 and 5% by weight of anti-caking agents, preferably between 0.1 and 5% by weight, with respect to the total weight of cerium containing abrasive.

Preferably, the weight ratio of anti-caking agents/cerium containing abrasive is comprised between 0.001 and 0.5, more preferably between 0.005 and 0.1.

The use of anti-caking agents in the formulation of the invention permits to increase the re-dispersion strength of said formulation as well as the polishing lifetime and surface quality of the phosphate glass or a fluorophosphate glass substrate. Moreover, even though the anticaking agent is in the form of solid particles, the formulation of the invention exhibit a similar or better removal rate without exhibiting a lesser amount of scratches than formulations without any anticaking agent.

e) Water

The liquid medium of the composition according to the invention comprises at least water and may also comprise another organic liquid, such as an organic solvent. The organic liquid and its content should preferably be selected so that there is no precipitation of the particles.

The liquid medium may be a water/water-miscible solvent mixture. As an example of a solvent of this type, mention may be made of alcohols such as methanol or ethanol, glycols such as ethylene glycol, acetate derivatives of glycols, such as ethylene glycol monoacetate, or polyols.

The liquid medium may also comprises an organic liquid, such as an organic solvent. As an example of an organic liquid, mention may be made of aliphatic hydrocarbons such as hexane, heptane, octane or nonane, inert cycloaliphatic hydrocarbons such as cyclohexane, cyclopentane or cycloheptane, aromatic hydrocarbons such as benzene, toluene, ethylbenzene, xylenes, or liquid naphthenes. Also suitable are petroleum fractions of the Isopar or Solvesso type (Trade Marks registered by the company Exxon), in particular Solvesso 100 which contains essentially a mixture of methylethylbenzene and trimethylbenzene, Solvesso 150 which contains a mixture of alkylbenzenes, in particular of dimethylbenzene and of tetramethylbenzene, and Isopar which contains essentially C11 and C12 isoparaffinic and cycloparaffinic hydrocarbons. Other types of petroleum fractions that may also be mentioned include those of Petrolink® type from the company Petrolink or of Isane® type from the company Total.

Chlorinated hydrocarbons, such as chlorobenzene, dichlorobenzene or chlorotoluene, can also be used as organic liquid. Aliphatic and cycloaliphatic ethers or ketones, for instance diisopropyl ether, dibutyl ether, methyl ethyl ketone, methyl isobutyl ketone, diisobutyl ketone or mesityl oxide, can be envisaged. Esters can be used, such as those derived from the reaction of acids with C₁-C₈ alcohols, and in particular palmitates of secondary alcohols such as isopropanol. By way of example, mention may be made of butyl acetate.

The liquid medium can be based on a mixture of two or more hydrocarbons or compounds of the type described above. The liquid medium can also comprise a mixture of two or more hydrocarbons or compounds of the type described above. As some organic liquid medium may be insoluble in water, it may be appropriate to use surfactants to achieve a micro-emulsion mixture for polishing slurry. The formulation may accordingly also be in the form of an emulsion or micro emulsion.

pH of the formulation of the invention is comprised between 7 and 14, preferably comprised between 9 and 13, more particularly between 11 and 13. pH adjuster and/or pH buffer may be added in the formulation for this purpose. Preferably additives to adjust the pH are chosen in the group constituted by: NaOH, KOH, Na₂HPO₄, K₂CO₃, Na₂CO₃, NaHCO₃, KHCO₃, and K₂HPO₄ or mixture thereof such as NaOH/Na₂HPO₄, KOH/K₂HPO₄, Na₂CO₃/NaHCO₃, and K₂CO₃/KHCO₃

Formulation of the present invention is preferably a suspension of cerium containing abrasive in the liquid medium.

Formulation of the present invention may also comprise a biocide, such as for instance Kordek™ MLX (methyl-4-isothiazolin-3-one), Kathon™ ICP III (2-methyl-4-isothiazolin-3-one and 5-chloro-2-methyl-4-isothiazolin-3-one), Kathon™ WT (5-chloro-2-methyl-2-hisothiazol-3-one and 2-methyl-2H-isothiazol-3-one), and SA plus+(bronopol) from 3D Bio-chem Co., Ltd.

Formulation of the invention may be produced in different ways, usually at a temperature comprised between 10 and 50° C.

It is notably possible to first prepare the slurry comprising the cerium containing abrasive and the liquid medium, and then, notably after a step of filtration, sieving and/or grinding, to add other additives such as the anionic water-soluble polymer dispersant and optionally a co-dispersant. Formulation of the invention may be obtained at this step, or further to a step of filtration and/or sieving.

Phosphate glass is a class of optical glasses composed of metaphosphates of various metals. Instead of SiO₂ in silicate glasses, the glass forming substrate is P₂O₅. Phosphate glasses can be advantageous over silica glasses for optical fibers with high concentration of doping rare earth ions. Introducing fluorine into phosphate glass through replacing metal oxide raw material with metal fluoride for instance will produce fluorophosphates glass. A glass made of a fluorophosphate glass usually has high gas barrier property, high transmittance in visible light region, and excellent weather resistance. The fluorophosphate glass may contain one or several other components such as CuO, SnO, B₂O₃, Al₂O₃, ZnO, TeO₂, alkali metal oxide (e.g. Li₂O, Na₂O or K₂O) and alkali earth metal oxide (e.g. CaO, MgO, SrO, BaO), besides a fluoride and P₂O₅.

The present invention also concerns a polished a phosphate glass or a fluorophosphate glass substrate susceptible to obtained by the method of the invention, as previously described.

The method according to the present invention also preferably involves a formulation exhibiting a redispersion strength comprised between 0.1 and 3%, the redispersion strength being determined by the following method:

The re-dispersion strength is evaluated by packing test method, with the packing ratio P %=(P3−P2)/P1, as follows: 50 g of abrasive powder (weight P1) is blended with 500 mL of water and an anionic water-soluble polymer dispersant an anti-caking agent, and optionally a co-dispersant, into a beaker (weight P2) and stirred, preferably with Ultra-Turrax, for 10 minutes at 4000 rpm/min. The mixture is then settled for 24 hours. The mixture is then stirred, preferably with blade stirrer MYP2011-250 Chijiu, at 250 rpm for 3 min. After stirring, the liquid medium is poured down and the weight of the beaker and bottom cake is measured (weight P3) after drying in an oven at 120° C.

The following examples are included to illustrate embodiments of the invention. Needless to say, the invention is not limited to described examples.

### EXPERIMENTAL PART

The materials used in the following examples were summarized in Table 1.

TABLE 1

| Additives | Producer |
|---|---|
| Cerox spring ® Ce/La oxide | Solvay |
| PAA: polyacrylate sodium | Jianghai Chem |
| HMP: sodium hexametaphosphate | Tianjing Yongsheng Fine Chem |
| LAP: Laponite | Rockwood |
| (Na—Li—Si—Mg—O—H) | |
| Biocide: SA-Plus + Bronopol | 3D Bio-chem Co., Ltd |

Preparation of Abrasive

The abrasive is Cerox® Spring intermediate oxide (Ce=60%; La=36%) that is calcined at a temperature 950° C. The resulting oxide is then added to water to an amount of 40% by weight of oxide. The slurry is then grinded into D50=0.4 μm, as measured by laser scattering method with HORIBA LA-920. Then a wet sieve through 200# mesh is used to obtain the final slurry for formulation. The abrasive is obtained by a drying step.

### Production of formulations

### Comparative Example 1 (CE1)

100 g of abrasive (grinded oxide) was dispersed into 900 g of water while keeping stirring for 30 min, at room temperature. The initial pH was 10.8.

### Comparative Example 2 (CE2)

100 g abrasive (Solvay Cerox® Spring intermediate oxide, grinded oxide) was dispersed into 900 g water, and then 2.5 g of PAA (effective concentration 30%) was added while keeping stirring for 30 min. The initial pH was 10.4 (no pH adjustment), at room temperature.

### Comparative Example 3 (CE3)

100 g abrasive (grinded oxide) was dispersed into 900 g of water, and then 2.5 g of PAA (effective concentration 30%) was added, and then 0.5 g of co-dispersant HMP was introduced, while keeping stirring for 30 min. The initial pH was 10.4 (no pH adjustment), at room temperature.

### Example 4 (E4)

100 g abrasive (grinded oxide) was dispersed into 900 g of water, and 2.5 g of PAA (effective concentration 30%) was added, and then 0.5 g of co-dispersant HMP was introduced, and then 1.0 g of Laponite was introduced, while keeping stirring for 30 min. The initial pH was 10.4 (no pH adjustment), at room temperature.

### Example 5 (E5)

100 g abrasive (grinded oxide) was dispersed into 900 g of water, and 2.5 g of PAA (effective concentration 30%) was added, and then 0.5 g of co-dispersant HMP was introduced, and then 1.0 g of Laponite was introduced, while keeping stirring for 30 min. Then 0.6 g of KOH was added to adjust pH to 12.0, while keep stirring 30 min, at room temperature.

### Example 6 (E6)

100 g abrasive (grinded oxide) was dispersed into 900 g of water, then 2.5 g of PAA (effective concentration 30%) was added, and then 0.5 g of co-dispersant HMP was introduced, and then 1.0 g of Laponite was introduced, while keeping stirring for 30 min. Then 0.6 g of KOH was added to adjust pH to 12.0, and then 3 g of K₂HPO₄, while keep stirring 30 min, at room temperature.

### Example 7 (E7)

100 g abrasive (grinded oxide) was dispersed into 900 g of water, and 2.5 g of PAA (effective concentration 30%) was added, and then 0.5 g of co-dispersant HMP was introduced, and then 1.0 g of Laponite was introduced, while keeping stirring for 30 min. Then 0.6 g of KOH and 3 g of K₂HPO₄ was added to adjust pH to 12.0, with 0.2 g of biocide, while keep stirring 30 min, at room temperature.

### Example 8 (E8)

100 g abrasive (grinded oxide) was dispersed into 900 g of water, then 2.5 g of PAA (effective concentration 30%) was added, 1.0 g of Laponite was introduced, while keeping stirring for 30 min. Then add 0.6 g of KOH was added to adjust pH to 12.0, with 0.2 g of biocide, while keep stirring 30 min, at room temperature.

Polishing Conditions

Polishing test machine: LM-15, commercially available from Baikowski. Co. Ltd. for STN glass polishing. For blue glass polishing, UNIPOL-160D two-side polisher from Shenyang Kejing Auto-instrument Co., Ltd is applied. Polishing conditions are as follows:

| | | |
|---|---|---|
| Substrate | Blue glass | STN glass |

| | | | | |
|---|---|---|---|---|
| Size of glass | 50*50*2 | mm | 100*100*1.2 | mm |

| | | |
|---|---|---|
| Polishing pad | SFMA | LP-66 |

| | | | | |
|---|---|---|---|---|
| Rotation speed | 19 | rpm | 90 | rpm |
| Slurry flow rate | 0.3 | L/min | 1 | L/min |
| Polishing load | 5.1 | kg | 15 | kg |
| Polishing time | 30 | min | 60 | min |

Results

The polishing compositions and their properties were summarized in the following Table 2 for blue glass and Table 3 for classical STN glass.

TABLE 2
(blue glass)

| | | | | | | Polishing | | | |
|---|---|---|---|---|---|---|---|---|---|
| | | | | | RR* | lifetime | Surface quality | | |
| | Formulation | pH | SS* | RS* | (μm/h) | (RR % after 4 h) | Scratch | Residue | Roughness |
| CE1 | CeO₂ only | 10.8 | D | B | 15.0 | −40% | D | D | D |
| CE2 | CeO₂ + PAA | 10.4 | B | D | 16.8 | −31% | C | C | C |
| CE3 | CeO₂ + PAA + HMP | 10.4 | A | D | 17.2 | −32% | C | C | C |
| E4 | CeO₂ + PAA + HMP + | 10.4 | A | C | 17.2 | −25% | C | B | C |
| | LAP | | | | | | | | |
| E5 | CeO₂ + PAA + HMP + | 12.0 | A | B | 20.4 | −24% | C | B | C |
| | LAP + KOH | | | | | | | | |
| E6 | CeO₂ + PAA + HMP + | 12.0 | A | A | 21.0 | −24% | B | B | B |
| | LAP + KOH/K₂HPO₄ | | | | | | | | |
| E7 | CeO₂ + PAA + HMP + | 12.0 | A | A | 22.8 | −20% | B | B | B |
| | LAP + KOH/K₂HPO₄ + | | | | | | | | |
| | biocide | | | | | | | | |
| E8 | CeO₂ + PAA + LAP + | 12.0 | B | B | 19.2 | −19% | C | B | C |
| | KOH + biocide | | | | | | | | |

*SS: suspension strength; RS: redispersion strength; RR: removal rate
A: Excellent/
B: Good/
C: Acceptable/
D: Bad

Table 2 shows that formulations of the invention can achieve an excellent slurry suspension property, suspension and re-dispersion at the same time, with improved blue glass polishing performance with respect to removal rate, polishing lifetime, scratch, residue and roughness.

TABLE 3
(classical STN glass)

| | | | RR | Polishing |
|---|---|---|---|---|
| | | | (μm/ | lifetime |
| | Formulation | pH | h) | (RR % after 2 h) |
| CE1 | CeO₂ only | 10.8 | 50 | −10% |
| CE3 | CeO₂ + PAA + HMP | 10.4 | 55 | −8% |
| E4 | CeO₂ + PAA + HMP + LAP | 10.4 | 54 | −8% |
| E6 | CeO₂ + PAA + HMP + LAP + | 12.0 | 58 | −7% |
| | KOH/K₂HPO₄ | | | |
| E7 | CeO₂ + PAA + HMP + LAP + | 12.0 | 58 | −7% |
| | KOH/K₂HPO₄ + biocide | | | |

A: Excellent/
B: Good/
C: Acceptable/
D: Bad

Table 3 shows that formulations of the invention demonstrate improved polishing performance on blue glass substrate with respect to removal rate and polishing lifetime, in comparison with classical STN polishing. Indeed, for instance formulation of example 6 shows an improvement of 40% of removal rate and a reduction of 40% of RR % after 4 h for blue glass polishing, in comparison with the formulation of comparative example 1 (cf Table 2). By contrast, formulation of example 6 only shows an improvement of 16% of removal rate and a reduction of 30% of RR % after 4 h for STN polishing, in comparison with the formulation of comparative example 1 (cf Table 23).

Method of Polishing Evaluation

(1) Removal Rate (RR): weigh the weight of glass plate before polishing M1 and the weight after polishing M2, RR=(M1−M2)*coefficient/time, unit μm/h. The coefficient is close linked to glass type and glass size. Polishing lifetime corresponds to the removal rate decay at a certain time.

(2) Surface quality: scratch and residue on glass substrate surface were observed by visual inspection (reflection+transmission) under halogen lamp (100V 300W) in dark room. The value is the average scratch or residue number for each piece of glass, for a total of 5 pieces checked. If the scratch number of <1 mm in length is more than 3 or the scratch size >1 mm in length is observed, the scoring belongs to D (bad and not acceptable). Roughness of polished surface corresponds to evaluation of surface Rₐ roughness as measured by Zygo Optical Surface Profilers.

(3) Suspension strength: Suspension strength is evaluated by sedimentation test: Firstly we have prepared a slurry comprising 2 wt % of abrasive as previously expressed that was transferred in a graduated cylinder of 50 mL. We have let the slurry settling for a 24 hours without stirring, then record the liquid volume of the clear supernate.

(4) Redispersion strength: The re-dispersion strength is evaluated by packing test method with the packing ratio as follows: P %=(P3−P2)/P1

50 g of abrasive powder (weight P1) is blended with 500 mL of water and additives as previously expressed into a beaker (weight P2) and stirred with Ultra-Turrax for 10 minutes at 4000 rpm/min. The mixture is then settled for 24 hours. The mixture is then stirred with blade stirrer MYP2011-250 Chijiu at 250 rpm for 3 min. After stirring, the liquid medium is poured down and the weight of the beaker and bottom cake is measured (weight P3) after drying in an oven at 120° C.

Ranking of each property is expressed as follows:

TABLE 4

| | | | Surface quality | | | |
|---|---|---|---|---|---|---|
| | | | Scratch count | | Residue | Roughness, |
| | SS, ml | RS, % | ≤1 mm | >1 mm | count | nm |
| A | ≤5 | ≤1.0 | ≤0.5 | 0 | ≤0.5 | ≤0.3 |
| B | 5-20 | 1.0-3.0 | 0.5-1.5 | 0 | 0.5-1.0 | 0.3-0.5 |
| C | 20-45 | 3.0-5.0 | 1.5-3.0 | 0 | 1.0-2.0 | 0.5-0.7 |
| D | >45 | >5.0 | >3.0 | 0 | >2.0 | >0.7 |

1. A method for polishing a phosphate glass or a fluorophosphate glass substrate, the method comprising polishing the surface of said glass or substrate using at least a formulation having a pH comprised between 7 and 14 and comprising at least:
a) a cerium containing abrasive;
b) an anionic water-soluble polymer dispersant;
c) optionally a co-dispersant;
d) an anti-caking agent; and
e) water.

2. The method according to claim 1 wherein the formulation comprises from 1 to 50% by weight of cerium containing abrasive, with respect to the total weight of the formulation.

3. The method according to claim 1 wherein the particle size distribution of the cerium containing abrasive is comprised between 0.1 to 3 μm.

4. The method according to claim 1 wherein the primary particle size of the cerium containing abrasives is comprised between 10 and 2000 nm.

5. The method according to claim 1 wherein the secondary particle size of the cerium containing abrasives is comprised between 100 and 5000 nm.

6. The method according to claim 1 wherein the anionic water-soluble polymer dispersants are selected from the group consisting of:
homopolymers of polyacrylic acid, polymaleic acid, or salts thereof, and
copolymers of monomers selected from acrylic acid, maleic acid, and salts thereof.

7. The method according to claim 1 wherein the anionic water-soluble polymer dispersants are polyacrylate salts.

8. The method according to claim 1 wherein the formulation comprises a co-dispersant.

9. The method according to claim 1 wherein the co-dispersants are selected from the group consisting of: inorganic polyphosphates, organic phosphonates, water-soluble nonionic dispersants, water-soluble cationic dispersants, and water-soluble amphoteric dispersants.

10. The method according to claim 1 wherein the anti-caking agent is selected from phyllosilicate minerals.

11. The method according to claim 1 wherein the anti-caking agent is at least one clay mineral selected from the group consisting of: smectite groups, kaolinite groups, vermiculite groups, chlorite groups, illite groups, serpentine groups, mica groups, talc groups, palygorskite (or attapulgit) groups, and organoclay groups.

12. The method according to claim 1 wherein the formulation comprises between 0.01 and 5% by weight of anti-caking agents.

13. The method according to claim 1 wherein the weight ratio of anti-caking agents to cerium containing abrasive is comprised between 0.001 and 0.5.

14. The method according to claim 1 wherein pH of the formulation is comprised between 11 and 13.

15. The method according to claim 1 wherein the formulation further comprises a biocide.

16. The method according to claim 1 wherein the formulation exhibits a redispersion strength comprised between 0.1 and 3%, the redispersion strength being determined by the following method:
blending 50 g of the cerium-containing abrasive powder (weight P1) with 500 mL of water, the anionic water-soluble polymer dispersant, the anti-caking agent, and optionally the co-dispersant, into a beaker (weight P2) to form a mixture;
stirring the mixture for 10 minutes at 4000 rpm/min;
allowing the mixture to settle for 24 hours;
stirring the mixture at 250 rpm for 3 min;
removing the liquid medium from the beaker and drying in an oven at 120° C.;
measuring the weight of the beaker and bottom cake after drying (weight P3);
wherein the re-dispersion strength is defined as the packing ratio P %=(P3−P2)/P1.

17. A polished phosphate glass or a fluorophosphate glass substrate susceptible to be obtained by the method according to claim 1.

18. The use of a formulation as defined in claim 1 for polishing a phosphate glass or a fluorophosphate glass substrate.

19. A polishing formulation comprising:
a) a cerium containing abrasive in an amount of 1 to 50% by weight, with respect to the total weight of the formulation;
b) an anionic water-soluble polymer dispersant in an amount between 0.001 and 5%, based on the weight of cerium containing abrasive;
c) optionally a co-dispersant in an amount between 0.01 and 3% by weight, based on the weight of cerium containing abrasive;
d) an anti-caking agent in an amount between 0.01 and 5% by weight, based on the weight of cerium containing abrasive; and
e) water;
wherein the formulation has a pH between 7 and 14.
